(19) United States
(12) Patent Application Publication
(10) Pub. No.: US 2026/0358290 A1
(43) Pub. Date: Nov. 12, 2026

(54) CURRENT COLLECTOR FOR COMBUSTION OXYGEN ANALYZERS

(71) Applicant: Rosemount Inc., Shakopee, MN (US)

(72) Inventors: Nicholas G GARTELOS, Eden Prairie, MN (US); Ye LIN, Eden Prairie, MN (US); Hallie K JONES, Minneapolis, MN (US); Dirk W. BAUSCHKE, Shakopee, MN (US); Samuel V HAARALA, Chaska, MN (US)

(21) Appl. No.: 19/464,814

(22) Filed: Jan. 30, 2026

Related U.S. Application Data
(60) Provisional application No. 63/800,679, filed on May 6, 2025.

(51) Int. Cl. G01N 27/407

(52) U.S. Cl. CPC G01N 27/4075

(57) ABSTRACT

A combustion oxygen analyzer includes an electronics housing, a probe, and a consumable oxygen cell. The probe is coupled to the electronics housing and is configured to contact a process medium. The probe has a first contact point. The consumable oxygen cell is disposed within the probe and includes a second contact point urged into contact with the first contact point. One of the first and second contact points is formed of a curved Inconel structure and the other of the first and second contact points is formed of platinum.

### CROSS-REFERENCE TO RELATED APPLICATIONS

The present application is based on and claims the benefit of U.S. Provisional Patent Application Serial No. 63/800,679 filed May 6, 2025, the content of which is hereby incorporated by reference in its entirety.

### BACKGROUND

Industrial processes often rely on energy sources such as combustion to generate steam or heat for a feed stock liquid. Some combustion processes involve operation of a furnace or boiler. While combustion provides a relatively low-cost energy source, combustion efficiency is often sought to be maximized within a process, because the resulting flue gases exiting the system may be subject to regulations regarding emissions of harmful gases. Accordingly, one goal of the combustion process management industry is to maximize combustion efficiency of existing furnaces and boilers, which inherently reduces the production of greenhouse gases and other harmful biproducts.

Combustion efficiency can be optimized by maintaining the ideal level of oxygen in the exhaust or flue gases coming from a combustion process, which ensures oxidation of the combustion biproducts. In-situ or in-process analyzers are commonly used in monitoring, optimizing, and/or controlling an on-going combustion process. Typically, such analyzers employ a sensor that is heated to relatively high temperatures and operates directly above or near the furnace or boiler combustion zone.

Known process combustion analyzers typically employ a zirconia-based oxygen sensor disposed at one end of a probe that is inserted into a flue gas stream. As the exhaust/flue gas flows into the sensor, it diffuses through a filter or diffuser into proximity with the zirconia-based oxygen sensor. There are no pumps or other flow inducing devices used to direct sample flow into the sensor. Instead, the gas penetrates passively through the diffuser. The sensor provides an electrical signal related to the amount of oxygen present in the flue gas.

The zirconia-based oxygen sensor provides a potentiometric indication that is deemed a reliable oxygen measurement in combustion environments permitting efficient and safe process control. Typically, a single probe is inserted through a process intrusion or insertion into the exhaust stack. A percent oxygen (O₂) measurement is used to control combustion efficiency in small boilers.

A typical in-situ analyzer with a zirconia potentiometric oxygen sensor provides a single point oxygen measurement for controlling combustion efficiency in power plants, incinerators, energy saving systems, refineries, chemical plants, or small combustors.

As set forth above, combustion analyzers are used to measure the concentration of excess oxygen in flue stacks. The O₂ cell, which typically attaches to the end of the probe, is generally considered to be a core sensing technology of the combustion analyzer. However, the O₂ cell is a consumable item and must periodically be replaced by the end user. When the O₂ cell is serviced in legacy installations, the probe frequently suffers irreparable damage to the sensor interface. Providing a solution that would not cause irreparable damage during such replacement would benefit the art of industrial combustion analyzers.

### SUMMARY

A combustion oxygen analyzer includes an electronics housing, a probe, and a consumable oxygen cell. The probe is coupled to the electronics housing and is configured to contact a process medium. The probe has a first contact point. The consumable oxygen cell is disposed within the probe and includes a second contact point urged into contact with the first contact point. One of the first and second contact points is formed of an Inconel disk and the other of the first and second contact points is formed of platinum.

### BRIEF DESCRIPTION OF THE DRAWINGS

FIG. 1 is a diagrammatic view of a combustion oxygen analyzer with which embodiments described herein are useful.

FIG. 2 is an enlarged cross-sectional view of an O₂ cell of a combustion oxygen analyzer.

FIGS. 3A – 3C show diffusion bonding of an O₂ cell discovered during metallurgical analysis.

FIGS. 4A and 4B show a fresh contact pad that is generally provided with O₂ sensors for replacement.

FIG. 5 is a diagrammatic view of a welded combustion probe in accordance with one embodiment of the present invention.

FIGS. 6A and 6B illustrate a wire and pad assembly for a combustion oxygen analyzer in accordance with an embodiment of the present invention.

FIG. 7 is a chart showing impedance data ranging from 100 kHz to 0.1 Hz in 736 ºC air for an oxygen sensor using an improved current collector compared to a prior current collector.

FIG. 8 is a chart comparing impedance data of an Inconel/Platinum interconnect vs a Platinum/Platinum interconnect illustrating similar impedance performance.

### DETAILED DESCRIPTION OF ILLUSTRATIVE EMBODIMENTS

An important design consideration for in-situ oxygen analyzers is to decrease the number of spares components managed by the end user by transitioning to a more robust, permanently sealed design requiring minimal maintenance. One important spare component that will remain due to its shorter service life is the O₂ cell which features a zirconia oxide sensor which typically contacts a platinum pad in the legacy oxygen analyzers to transmit an electrical signal proportional to the oxygen concentration of the process.

In the legacy design, the platinum pad of the oxygen analyzer and the interface with the zirconia oxide sensor can generate diffusion bonding, which can damage the platinum pad of the oxygen analyzer when removing the O₂ cell. In the past, the potential for this damage has necessitated the inclusion of a spare platinum pad in the O₂ cell spares kit which is undesirable for the end user to install as it adds cost and requires a full disassembly of the internal analyzer components. An alternative to the legacy platinum pad design was needed to increase the durability of the contacting surface in order survive many changes of O₂ cells. After testing, a new interface was developed and implemented to carry the signal from the zirconia oxide sensor without causing diffusion bonding, thereby allowing for a longer analyzer life.

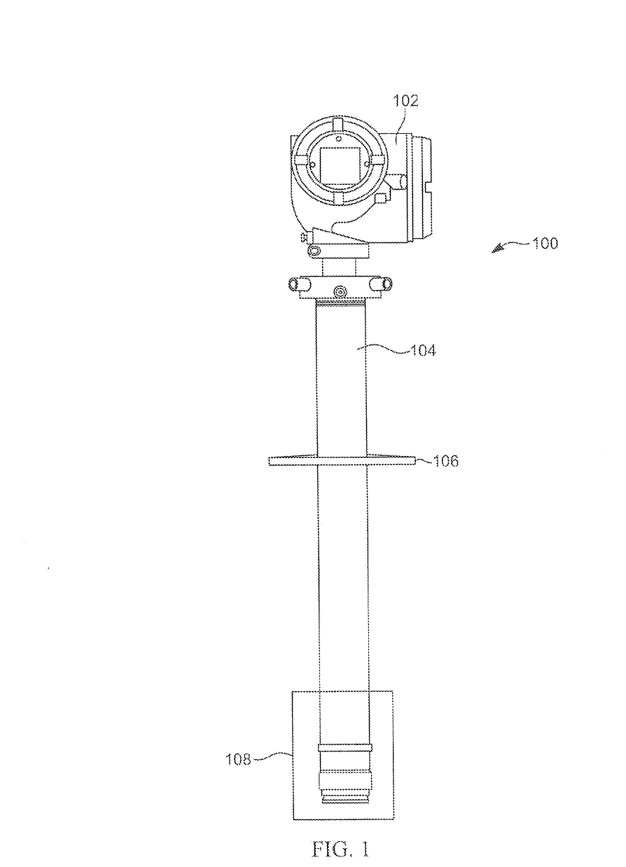

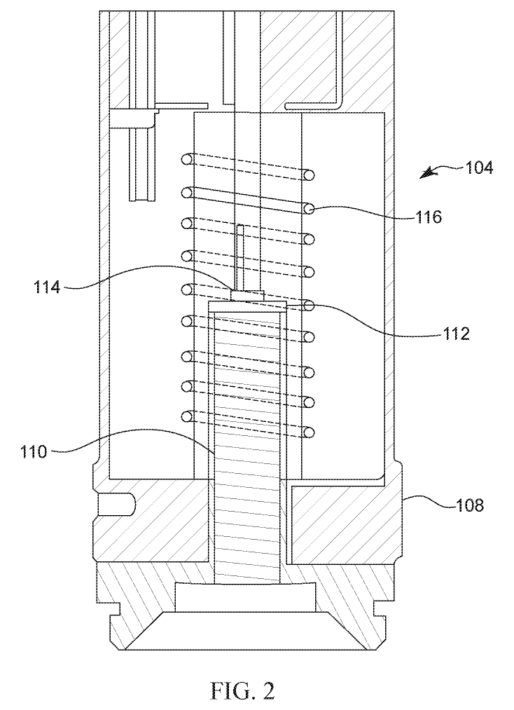

FIG. 1 is a diagrammatic view of a combustion oxygen analyzer with which embodiments described herein are useful. Combustion oxygen analyzer 100 includes an electronics housing 102 coupled to a probe 104 that is configured to extend into a process gas source, such as a combustion flue. A flange 106 on probe 104 is configured to mount analyzer 100 to a sidewall of the flue. An oxygen sensor (shown in FIG. 2) is generally located near a distal end 108 of probe 104.

FIG. 2 is an enlarged cross-sectional view of distal end 108 of probe 104 showing a replaceable O₂ cell. As set forth above, O₂ cell 110 attaches to distal end 108 of probe 104 and is an important component of the analyzer but is considered to be consumable as it must periodically be replaced. As can be seen in FIG. 2, O₂cell 110 includes a contact 112 that is urged against permanent pad 114. These two contact points 112, 114 are generally urged together by spring 116 or some other suitable bias force. The permanent contact pad 114 touching the sensor interface (interface contact points 112, 114) under the force of spring 116 during operation, which subjects the probe 104 to elevated temperatures, can cause diffusion bonding between the two contact points 112 and 114. The diffusion bonding can cause damage to permanent pad 114 when the sensor is replaced since contact point 112 is bonded to permanent pad 114. It is noted that diffusion bonding is caused by continuous pressure applied to noble metals in contact at elevated temperatures for long periods of time. As the contact interface on the O₂ cell and legacy pad are both comprised of a platinum mesh and are maintained at a constant mechanical pressure via spring force, a greater contact area for diffusion bonding is available, further intensifying its destructive impact.

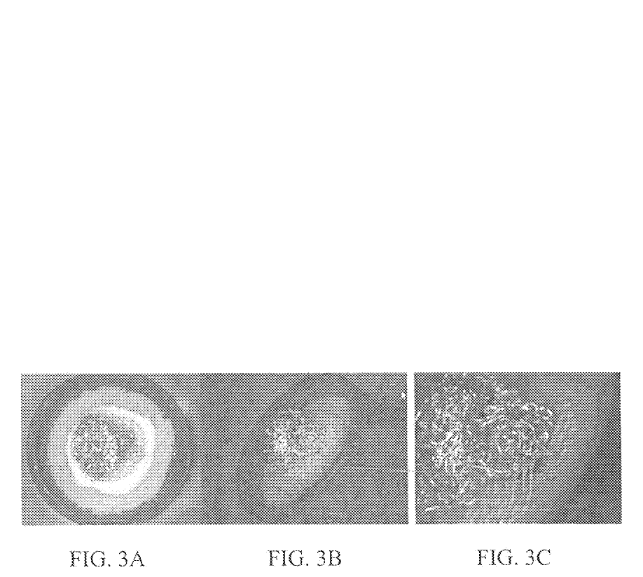

FIGS. 3A – 3C show diffusion bonding of an O₂ cell. As can be seen, the images show the effects of and confirm diffusion bonding between the contact points. More specifically, diffusion bonding caused of the platinum mesh assembly to stick to the platinum interface on the Zirconia Oxide O₂ cell. When such diffusion bonding occurs, the replacement of the O₂ cell becomes considerably more difficult and time-consuming resulting in downtime and repair difficulty which can adversely impact end users’ experiences in operating their combustion processes. Process shutdowns are very costly and must be reduced to a minimum. To replace an O₂ cell, a technician will generally remove the probe from the process by removing the flange bolts. The technician will then unthread the diffuser or flame arrestor assembly to access the O₂ cell. Typically, four hex-head screws are removed to free the O₂ cell from the device. Then a new O₂ cell is inserted into the probe and re-secured with the four screws. Finally, the diffuser or flame arrestor is replaced, and the probe is installed back into the customer’s process with the flange bolts.

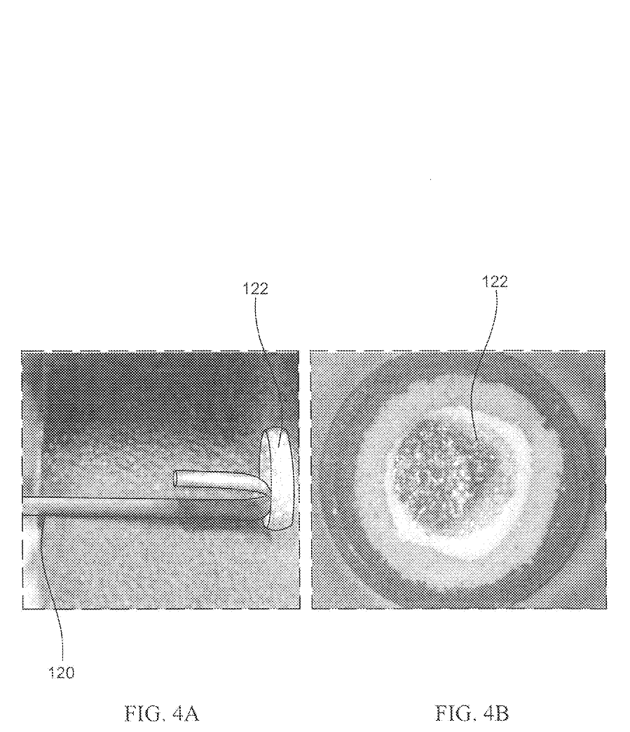

To mitigate the risk of longer downtimes when replacing the O₂ sensor, a fresh contact pad (shown in FIG. 4A) is typically included with sensor replacements if diffusion bonding has occurred. Often the wire 120 and pad 122 assembly is not necessary because diffusion bonding has not occurred to the extent to damage the permanent pad. In such cases, wire 120 and pad 122 are simply discarded. When the legacy platinum mesh does stick or otherwise suffers from enough diffusion bonding to damage the permanent pad, O₂ cell replacement is a much more involved and costly process for the end user. In addition to the steps listed above, the technician must replace the internal platinum mesh and wire assembly which runs the entire length of probe 104. The replacement process can be challenging as the probes are often installed high up on flue exhaust stacks. Probes are also available in up to 12’ lengths, making this an extremely difficult process if not on ground level. A probe may need to be removed from the stack and taken to a repair location for full replacement. The technician would typically start such a process by removing the transmitter from the probe to access an internal strut. The internal strut is then pulled out of the probe which is a difficult task due to high levels of friction throughout the length of the tube. Next the platinum mesh 122 and wire 120 assembly are removed from the entire length of the strut and replaced with the fresh one from the O₂ cell kit. This can also be a difficult step as the technician must feed up to twelve feet of wire through a small alumina tube in the center of a strut.

FIG. 4B is an enlarged view showing an end view of platinum mesh 122 that is typically provided with an O₂ cell replacement kit.

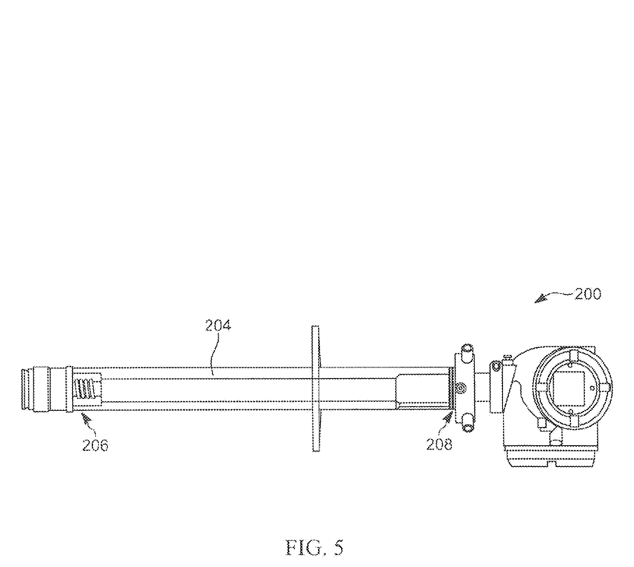

FIG. 5 is a diagrammatic view of a welded combustion probe in accordance with one embodiment of the present invention. To reduce the maintenance efforts for end users, a new In-Situ Oxygen Analyzer 200 is provided such that the probe 204 itself does not require any servicing and is welded completely shut at welds 206, 208. As described above, the O₂ cell is consumable and is replaced after it no longer calibrates properly. However, because of the new welded probe design, replacement of the platinum pad 122 and wire 120 assembly is not possible.

In accordance with embodiments described herein, a new solution is provided for the contact points between the consumable O₂ cell and the permanent pad of the oxygen analyzer. Since the contacting surface of the permanent pad must outlast many changes of O₂ cells, diffusion bonding was squarely addressed. Embodiments described herein generally pair the welded probe design with substituting a curved Inconel 625 structure, such as a disk, cylinder, or ball and wire assembly for the permanent platinum pad 114 (shown in FIG. 2). This new design significantly simplifies the repair process by addressing the two main attributes contributing to diffusion bonding: material compatibility and degree of contact. The curved Inconel structure is a solid, flat surface that contacts the outermost face of the platinum mesh on the O₂ sensor. The reduced surface area of this interface as well as the use of dissimilar metals significantly reduces the opportunity for diffusion bonding, achieving the goal of a longer lifespan for the product.

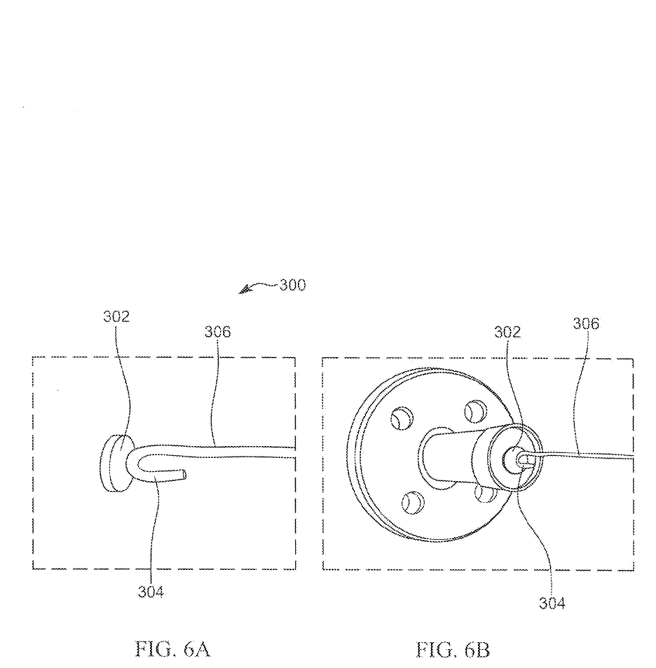

FIGS. 6A and 6B illustrate a wire and pad assembly for a combustion oxygen analyzer in accordance with an embodiment of the present invention. In addition to increasing durability, the Inconel 625 disk, illustrated at reference numeral 302, reduces cost and improves manufacturing efficiency. The disk assembly 300 consists of two parts and a two-step assembly process. First the tip of the wire 304 is bent to create a larger welding surface and to prevent assembly 300 from rotating when installed into the strut. Then the Inconel wire 306 is resistance welded to the Inconel 625 disk 302, forming a strong joint designed to withstand worst-case O₂ cell removal force. The wire and pad assembly 300 are spring loaded to always be in contact with the sensor. A number of tests were conducted to verify the performance of the Inconel 625 disk compared to the platinum pad, evaluating the key metrics of system impedance, O₂ measurement stability, and signal stabilization time. All probes were able to successfully calibrate, generating calibration constants within tolerance, and there was no discernible difference when using the transmitter or receiving data from the sensor.

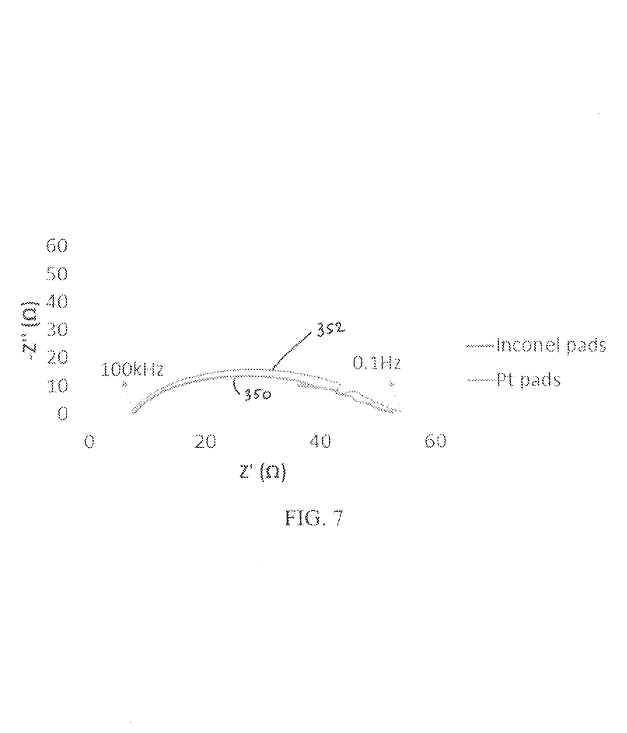

FIG. 7 is a chart showing impedance data ranging from 100 kHz to 0.1 Hz in 736ºC air for an oxygen sensor using an improved current collector compared to a prior current collector. FIG. 7 is a Nyquist plot of full sensing cells with Inconel disk/Pt+YSZ/YSZ/Pt+YSZ/Inconel disk and Pt pad/Pt+YSZ/YSZ/Pt+YSZ/Pt pad at 736°C in air. Note, YSZ is Yttria-stabilized zirconia. The Inconel plot is labeled with reference numeral 350 and the platinum plot is labeled with reference numeral 352. The potential differences in contact resistance were investigated by analyzing impedance data ranging from 100 kHz to 0.1 Hz at 736°C in air. A symmetrical cell test setup was used to run the test. The bulk resistance at high frequency (100 kHz) was found to be similar between cells with Inconel disks (7.8 ohm) and cells with platinum pads (7.5 ohm) used in legacy probes. This indicates the effectiveness of replacing platinum pads with Inconel disks for the purpose of the current collection from the sensing layers. At the same time, the polarization resistance (Rp) was 44.9 ohm and 46.52 ohm for the cells with Inconel disks and cells with platinum pads, respectively. Since Rp is closely related to the oxygen sensing performance, the replacement of platinum pads with Inconel disks showed no impact on the oxygen sensing performance.

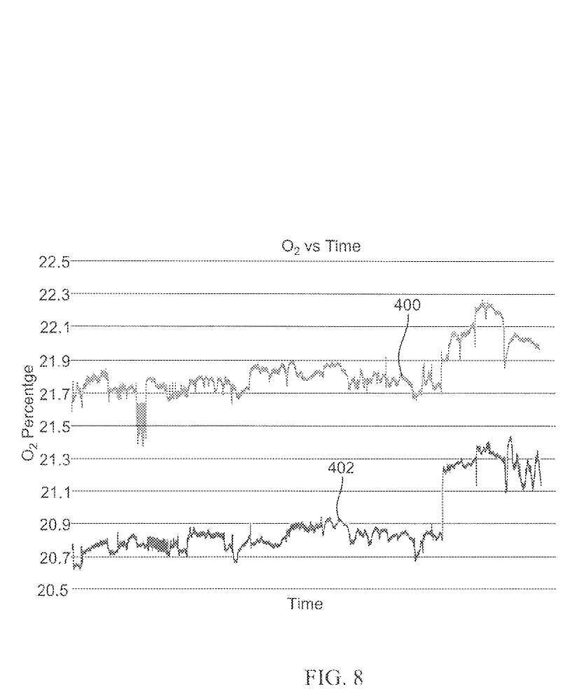

FIG. 8 is a chart comparing impedance data of an Inconel/Platinum interconnect vs a Platinum/Platinum interconnect illustrating similar impedance performance. FIG. 8 is a Nyquist plot of a symmetrical cell test setup used to collect the impedance data. To compare O₂ measurement stability, two cells, one with an Inconel disk (plot 400) and the other with a platinum pad (plot 402), were operated simultaneously for a two-month period. The cell with the Inconel disk exhibited a similar oxygen reading trend throughout the test as the cell with the platinum pad, indicating comparable performance between the Inconel and platinum pads. Additionally, the time required for the probe to reach a steady reading once powered on was evaluated. It was observed that the Inconel disk takes notably less time to stabilize at the ambient 21% O₂ reading, reaching this value within 24 hours while the platinum pad requires approximately two to three days of run-time to achieve stability. The shorter stabilization period of the Inconel disk allows the user to calibrate a new probe faster, further reducing the process downtime for servicing as compared to the platinum pad.

While embodiments have been described with respect to an Inconel 625 disk, it is noted that the Inconel disk could be pre-oxidized to reduce the effect of Chromium deposition on signal stabilization period. Finally, a sintered Inconel disk could be used or EDM cutting could be performed on a solid Inconel disk to increase porosity and oxygen flow for improved response time.

Although the present invention has been described with reference to preferred embodiments, workers skilled in the art will recognize that changes may be made in form and detail without departing from the spirit and scope of the invention.

What is claimed is:

1. A combustion oxygen analyzer comprising:
an electronics housing;
a probe coupled to the electronics housing, the probe being configured to contact a process medium, the probe having a first contact point;
a consumable oxygen cell disposed within the probe, the consumable oxygen cell having a second contact point urged into contact with the first contact point; and
wherein one of the first and second contact points is formed of a curved Inconel structure and the other of the first and second contact points is formed of platinum.

2. The combustion analyzer of claim 1, wherein the first contact point is formed of an Inconel disk.

3. The combustion analyzer of claim 2, wherein the Inconel disk is formed of Inconel 625.

4. The combustion analyzer of claim 2, wherein the second contact point is formed of platinum mesh.

5. The combustion analyzer of claim 1, wherein the first and second contact points are urged into contact with one another.

6. The combustion analyzer of claim 5, wherein the first and second contact points are urged into contact with one another by a spring.

7. The combustion analyzer of claim 1, wherein an electrical connection between the first contact point and electronics within the transmitter housing is via a nickel-based alloy wire attached to the curved Inconel structure.

8. The combustion analyzer of claim 7, wherein the nickel-based alloy wire is formed of Inconel.

9. The combustion analyzer of claim 7, wherein the nickel-based alloy wire is welded to the Inconel disk.

10. The combustion analyzer of claim 1, wherein the curved Inconel structure is a solid Inconel disk.

11. The combustion analyzer of claim 1, wherein the probe is welded.

12. The combustion analyzer of claim 11, wherein the probe includes a first weld proximate the consumable oxygen cell and a second weld proximate the electronics housing.

13. The combustion analyzer of claim 1, wherein the curved Inconel structure is an Inconel disk.

14. The combustion analyzer of claim 1, wherein the curved Inconel structure is an Inconel cylinder.

15. The combustion analyzer of claim 1, wherein the curved Inconel structure is an Inconel ball.

16. A wire and pad assembly for a combustion oxygen analyzer, the wire and pad assembly comprising:
a nickel-based alloy wire;
a curved Inconel structure attached to the nickel-based alloy wire, the curved Inconel structure being configured to make electrical contact with a Zirconia-based oxygen cell; and
wherein the nickel-based alloy wire is configured to extend through a probe of the combustion oxygen analyzer.

17. The wire and pad assembly of claim 16, wherein the wire includes a hook structure proximate an attachment potion where the wire is attached to the curved Inconel structure.

18. The wire and pad assembly of claim 16, wherein the nickel-based wire is formed of Inconel.

19. The wire and pad assembly of claim 18, wherein the nickel-based wire is welded to the curved Inconel structure.

20. The wire and pad assembly of claim 16, wherein the nickel-based wire is resistance welded to the curved Inconel structure.

21. The wire and pad assembly of claim 16, wherein the curved Inconel structure is a solid Inconel disk.
